(19) United States
(12) Patent Application Publication
(10) Pub. No.: US 2025/0365727 A1
(43) Pub. Date: Nov. 27, 2025

(54) COMMUNICATION METHOD AND COMMUNICATION APPARATUS

(71) Applicant: HUAWEI TECHNOLOGIES CO., LTD., Shenzhen (CN)

(72) Inventor: Yue Zhou, Shenzhen (CN)

(73) Assignee: HUAWEI TECHNOLOGIES CO., LTD., Shenzhen (CN)

(21) Appl. No.: 19/294,602

(22) Filed: Aug. 8, 2025

Related U.S. Application Data
(63) Continuation of application No. PCT/CN2024/077092, filed on Feb. 9, 2024.

(30) Foreign Application Priority Data
Feb. 10, 2023 (CN) 202310125119.0

(51) Int. Cl. H04W 72/1268; H04B 7/06

(52) U.S. Cl. CPC H04W 72/1268; H04B 7/0602

(57) ABSTRACT

A communication method and a communication apparatus. In the method, a terminal device determines N time windows based on uplink scheduling information delivered by a network device, where the N time windows are used for uplink transmission. The terminal device performs N times of antenna switching when the N time windows are used for the uplink transmission. According to the method, balance between a coding gain, a channel estimation gain, and a spatial diversity gain can be achieved, and proper communication quality of uplink transmission can be obtained.

### CROSS-REFERENCE TO RELATED APPLICATIONS

This application is a continuation of International Application No. PCT/CN2024/077092, filed on Feb. 9, 2024, which claims priority to Chinese Patent Application No. 202310125119.0, filed n on Feb. 10, 2023. The disclosures of the aforementioned applications are hereby incorporated by reference in their entireties.

### TECHNICAL FIELD

The embodiments relate to the communication field, and to a communication method and a communication apparatus.

### BACKGROUND

Channel fading exists in communication channels of various communication systems, and diversity in time domain, frequency domain, or spatial domain may be used to improve coverage performance of a radio link. When a network device communicates with a terminal device, the terminal device is affected by factors such as power consumption, costs, and a size. Although a plurality of antennas are configured to implement multi-antenna receiving, when the terminal device uses a single antenna to send a signal, a spatial diversity gain cannot be achieved, causing problems such as interrupted communication and low network efficiency.

### SUMMARY

The embodiments provide a communication method and a communication apparatus to obtain proper communication quality.

According to a first aspect, a communication method is provided. The method may be performed by a terminal device, or may be performed by a chip or a circuit configured in the terminal device. This is not limited.

The method may include: the terminal device receives first information from a network device, where the first information is used to schedule uplink transmission. The terminal device determines N first time windows based on the first information. The N first time windows are used for the uplink transmission, the uplink transmission includes N times of antenna switching, and the N first time windows one-to-one correspond to the N times of antenna switching.

Based on the foregoing solution, the terminal device may determine, based on uplink scheduling information of the network device, the N time windows used for uplink transmission, and each of the N time windows is used to perform uplink transmission on a switched antenna port. This can implement a spatial diversity gain, and obtain proper communication quality of uplink transmission.

With reference to the first aspect, in some implementations or embodiments of the first aspect, that the terminal device determines the N first time windows based on the first information includes: the terminal device determines a first time interval based on the first information, and determines the N first time windows based on the first time interval.

With reference to the first aspect, in some implementations or embodiments of the first aspect, the method further includes: the terminal device sends second information to the network device. The second information includes at least one antenna port combination corresponding to each of at least one number of antenna ports used by the terminal device to perform the uplink transmission, and/or the second information includes at least one antenna port combination number corresponding to each of at least one number of antenna ports used by the terminal device to perform the uplink transmission.

For example, when the second information includes a plurality of antenna port combination numbers corresponding to a plurality of antenna port numbers, the first information further indicates a number of antenna ports used by the terminal device to perform the uplink transmission.

Optionally, when the second information includes one antenna port combination number corresponding to one antenna port number, the network device may not need to indicate, to the terminal device, the number of antenna ports used by the terminal device to perform the uplink transmission.

Based on the foregoing solution, balance between a coding gain, a channel estimation gain, and a spatial diversity gain can be achieved, and proper communication quality of uplink transmission can be obtained.

With reference to the first aspect, in some implementations or embodiments of the first aspect, that the terminal device determines the N first time windows based on the first information includes: the terminal device determines the N first time windows based on the first information and the second information.

With reference to the first aspect, in some implementations or embodiments of the first aspect, the first information includes at least one of the following information:
a number of slots for repetition in the uplink transmission, a number of slots for transport block processing over multiple slots (TBoMS) in the uplink transmission, and third information, where the third information indicates whether joint channel estimation (JCE) is allowed, and the JCE is performing channel estimation, based on demodulation reference signals (DMRS) sent in a plurality of slots, on physical uplink control channels (PUCCHs)/physical uplink shared channels (PUSCHs) transmitted in the plurality of slots.

For example, the terminal device stores a plurality of mapping relationships between the first information and the N time windows. The terminal device may determine the N time windows based on the plurality of mapping relationships. The mapping relationship may be negotiated by the terminal device and the network device in advance, or may be specified in a protocol. This is not limited.

For example, when the third information indicates that JCE is allowed, and the number of slots for repetition in the uplink transmission is greater than 1, the terminal device may determine the N time windows based on a first mapping relationship.

When the third information indicates that JCE is allowed, the number of slots for repetition in the uplink transmission is greater than 1, and the terminal device has an antenna switching report capability, the terminal device may determine the N time windows based on a second mapping relationship.

When the third information indicates that JCE is allowed, the number of slots for repetition in the uplink transmission is equal to 1 or the first information does not include the number of slots for repetition in the uplink transmission, and the terminal device has the antenna switching report capability, the terminal device may determine the N time windows based on a third mapping relationship.

When the third information indicates that JCE is not allowed, and the number of slots for repetition in the uplink transmission is greater than 1, the terminal device may determine the N time windows based on a fourth mapping relationship.

When the third information indicates that JCE is not allowed, and the number of slots for repetition in the uplink transmission is equal to 1 or the first information does not include the number of slots for repetition in the uplink transmission, the terminal device may determine the N time windows based on a fifth mapping relationship.

Based on the foregoing solution, balance between a coding gain, a channel estimation gain, and a spatial diversity gain can be achieved, and proper communication quality of uplink transmission can be obtained.

With reference to the first aspect, in some implementations or embodiments of the first aspect, the first information further includes a second time interval, and the second time interval is a time interval for a frequency hopping operation in the uplink transmission performed by the terminal device.

Based on the foregoing solution, balance between a coding gain, a channel estimation gain, a frequency diversity gain, and a spatial diversity gain can be achieved, and proper communication quality of uplink transmission can be obtained.

With reference to the first aspect, in some implementations or embodiments of the first aspect, the method further includes: the terminal device receives fourth information from the network device, where the fourth information indicates that the terminal device is allowed to perform antenna switching.

According to a second aspect, a communication method is provided. The method may be performed by a network device, or may be performed by a chip or a circuit configured in a network device. This is not limited.

The method may include: the network device sends first information to a terminal device, where the first information is used to schedule uplink transmission. The network device determines N first time windows based on the first information. The N first time windows are used for the uplink transmission, the uplink transmission includes N times of antenna switching, and the N first time windows one-to-one correspond to the N times of antenna switching.

Based on the foregoing solution, the network device may determine, based on uplink scheduling information, the N time windows used for uplink transmission, and each of the N time windows is used to perform uplink transmission on a switched antenna port. This can implement a spatial diversity gain, and obtain proper communication quality of uplink transmission.

With reference to the second aspect, in some implementations or embodiments of the second aspect, that the network device determines the N first time windows based on the first information includes: The network device determines a first time interval based on the first information, and determines the N first time windows based on the first time interval.

With reference to the second aspect, in some implementations or embodiments of the second aspect, the method further includes: the network device receives second information from the terminal device. The second information includes at least one antenna port combination corresponding to each of at least one number of antenna ports used by the terminal device to perform the uplink transmission, and/or the second information includes at least one antenna port combination number corresponding to each of at least one number of antenna ports used by the terminal device to perform the uplink transmission.

For example, when the second information includes a plurality of antenna port combination numbers corresponding to a plurality of antenna port numbers, the first information further indicates a number of antenna ports used by the terminal device to perform the uplink transmission.

Optionally, when the second information includes one antenna port combination number corresponding to one antenna port number, the network device may not need to indicate, to the terminal device, the number of antenna ports used by the terminal device to perform the uplink transmission.

Based on the foregoing solution, balance between a coding gain, a channel estimation gain, and a spatial diversity gain can be achieved, and proper communication quality of uplink transmission can be obtained.

With reference to the second aspect, in some implementations or embodiments of the second aspect, that the network device determines the N first time windows based on the first information includes: the network device determines the N first time windows based on the first information and the second information.

With reference to the second aspect, in some implementations or embodiments of the second aspect, the first information includes at least one of the following information:
a number of slots for repetition in the uplink transmission, a number of slots for TBoMS in the uplink transmission, and third information, where the third information indicates whether the network device supports JCE, and the JCE is performing joint channel estimation, based on DMRS sent in a plurality of slots, on a channel of the TBoMS.

For example, the network device stores a plurality of mapping relationships between the first information and the N time windows. The network device may determine the N time windows based on the plurality of mapping relationships. The mapping relationship may be negotiated by the terminal device and the network device in advance, or may be specified in a protocol. This is not limited.

For example, when the third information indicates that JCE is allowed, and the number of slots for repetition in the uplink transmission is greater than 1, the network device may determine the N time windows based on a first mapping relationship.

When the third information indicates that JCE is allowed, the number of slots for repetition in the uplink transmission is greater than 1, and the terminal device reports an antenna switching capability to the network device, the network device may determine the N time windows based on a second mapping relationship.

When the third information indicates that JCE is allowed, the number of slots for repetition in the uplink transmission is equal to 1 or the first information does not include the number of slots for repetition in the uplink transmission, and the terminal device reports the antenna switching capability to the network device, the network device may determine the N time windows based on a third mapping relationship.

When the third information indicates that JCE is not allowed, and the number of slots for repetition in the uplink transmission is greater than 1, the network device may determine the N time windows based on a fourth mapping relationship.

When the third information indicates that JCE is not allowed, and the number of slots for repetition in the uplink transmission is equal to 1 or the first information does not include the number of slots for repetition in the uplink transmission, the network device may determine the N time windows based on a fifth mapping relationship.

Based on the foregoing solution, balance between a coding gain, a channel estimation gain, and a spatial diversity gain can be achieved, and proper communication quality of uplink transmission can be obtained.

With reference to the second aspect, in some implementations or embodiments of the second aspect, the first information further includes a second time interval, and the second time interval is a time interval for a frequency hopping operation in the uplink transmission performed by the terminal device.

Based on the foregoing solution, balance between a coding gain, a channel estimation gain, a frequency diversity gain, and a spatial diversity gain can be achieved, and proper communication quality of uplink transmission can be obtained.

With reference to the second aspect, in some implementations or embodiments of the second aspect, the method further includes: the network device sends fourth information to the terminal device, where the fourth information indicates that the terminal device is allowed to perform antenna switching.

According to a third aspect, a communication apparatus is provided. The apparatus is configured to perform the method provided in the first aspect. For example, the apparatus may include modules configured to perform the first aspect and any possible implementation or embodiments of the first aspect.

According to a fourth aspect, a communication apparatus is provided. The apparatus is configured to perform the method provided in the second aspect. For example, the apparatus may include modules configured to perform the second aspect and any possible implementation or embodiments of the second aspect.

According to a fifth aspect, a communication apparatus is provided, and includes a processor. The processor is coupled to a memory, and may be configured to execute instructions in the memory, to implement the method in the first aspect and any possible implementation or embodiment of the first aspect. Optionally, the apparatus further includes the memory. Optionally, the apparatus further includes a communication interface, and the processor is coupled to the communication interface.

In an implementation or embodiment, the apparatus is a terminal device. When the apparatus is the terminal device, the communication interface may be a transceiver or an input/output interface.

In another implementation or embodiment, the apparatus is a chip configured in a terminal device. When the apparatus is the chip configured in the terminal device, the communication interface may be an input/output interface.

In another implementation or embodiment, the apparatus is a chip or a chip system.

Optionally, the transceiver may be a transceiver circuit. Optionally, the input/output interface may be an input/output circuit.

According to a sixth aspect, a communication apparatus is provided and includes a processor. The processor is coupled to a memory, and may be configured to execute instructions in the memory, to implement the method in the second aspect and any possible implementation of the second aspect. Optionally, the apparatus further includes the memory. Optionally, the apparatus further includes a communication interface, and the processor is coupled to the communication interface.

In an implementation or embodiment, the apparatus is a network device. When the apparatus is the network device, the communication interface may be a transceiver or an input/output interface.

In another implementation or embodiment, the apparatus is a chip configured in a network device. When the apparatus is the chip configured in the network device, the communication interface may be an input/output interface.

In another implementation or embodiment, the apparatus is a chip or a chip system.

Optionally, the transceiver may be a transceiver circuit. Optionally, the input/output interface may be an input/output circuit.

According to a seventh aspect, a non-transitory computer-readable storage medium is provided. The non-transitory computer-readable storage medium stores computer instructions, and when the computer instructions are executed by an apparatus, the apparatus is enabled to implement the method in the first aspect and any possible implementation or embodiment of the first aspect.

According to an eighth aspect, a non-transitory computer-readable storage medium is provided. The non-transitory computer-readable storage medium stores computer instructions, and when the computer instructions are executed by an apparatus, the apparatus is enabled to implement the method in the second aspect and any possible implementation or embodiment of the second aspect.

According to a ninth aspect, a computer program product including instructions is provided. The computer program product includes a computer program. When the computer program is executed by an apparatus, the apparatus is enabled to implement the method in the first aspect and any possible implementation or embodiment of the first aspect.

According to a tenth aspect, a computer program product including instructions is provided. The computer program product includes a computer program. When the computer program is executed by an apparatus, the apparatus is enabled to implement the method in the second aspect and any possible implementation or embodiment of the second aspect.

According to an eleventh aspect, a communication system is provided and includes the foregoing terminal device and network device.

### BRIEF DESCRIPTION OF DRAWINGS

FIG. 1 is a diagram of an example of a network architecture to which an embodiment is applicable;

FIG. 2 is a schematic flowchart of an example of a communication method to which an embodiment is applicable;

FIG. 3 is a schematic flowchart of another example of a communication method to which an embodiment is applicable;

FIG. 4 is a block diagram of a communication apparatus according to an embodiment;

FIG. 5 is a block diagram of a communication apparatus according to an embodiment; and

FIG. 6 is a diagram of a chip system according to an embodiment.

### DETAILED DESCRIPTION OF EMBODIMENTS

The following describes solutions of the embodiments with reference to accompanying drawings.

The solutions provided in the embodiments may be applied to various communication systems, for example, a 5th generation (5G) or new radio (NR) system, a long term evolution (LTE) system, an LTE frequency division duplex (FDD) system, an LTE time division duplex (TDD) system, or a satellite communication system. The solutions provided in the embodiments may be further applied to future communication systems such as a 6th generation mobile communication system. The solutions provided in the embodiments may be further applied to device-to-device (D2D) communication, vehicle-to-everything (V2X) communication, machine-to-machine (M2M) communication, machine type communication (MTC), an Internet of things (IoT) communication system, or another communication system.

The following describes the solutions of the embodiments by using a satellite communication system as an example.

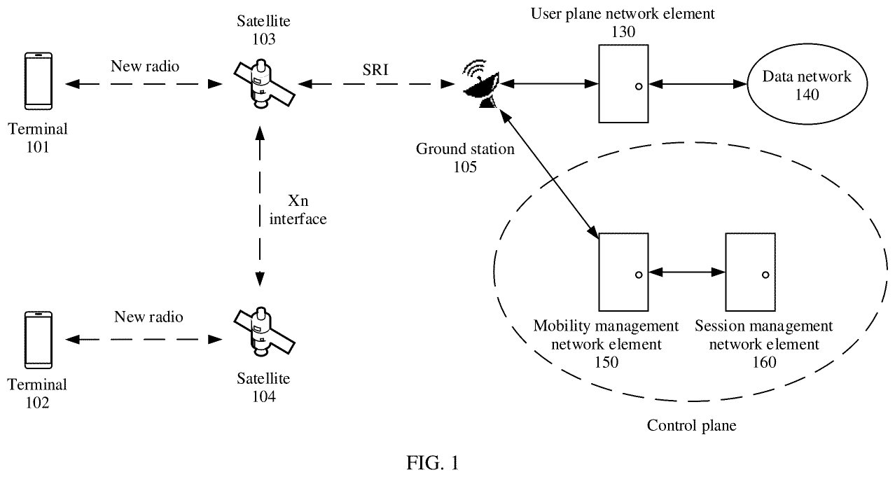

FIG. 1 is a diagram of a network architecture to which a solution of the embodiments may be applied.

The network architecture in which the satellite communication system integrated with 5G shown in FIG. 1 includes at least one terminal (for example, a terminal 101 and a terminal 102 in FIG. 1), at least one satellite (for example, a satellite 103 and a satellite 104 in FIG. 1), at least one ground station (gateway) (for example, a ground station 105 in FIG. 1), a user plane network element 130, a data network 140, and a core network control plane network element (for example, a mobility management network element 150 and a session management network element 160). The ground station may also be referred to as a gateway, a gateway station, or the like, and the following uniformly uses a ground station.

A link between the satellite and the terminal is referred to as a service link. A link between the satellite and the ground station is a feeder link.

When the satellite works in a transparent transmission mode, the satellite has a relay and forwarding function. Optionally, the ground station has functions of a base station or some functions of a base station, and the ground station may be considered as a ground base station. Optionally, the ground base station and the ground station may alternatively be separately deployed. In a 5G communication system, a ground terminal accesses a network through 5G new radio, and a 5G network device is deployed on the ground. In the embodiments, the ground station or the ground base station that has functions of the base station or some functions of the base station is referred to as a network device.

When the satellite works in a regenerative mode, the satellite has a data processing capability, and functions of a base station or some functions of a base station, and the satellite may be considered as a base station. In the 5G communication system, a ground terminal accesses a network through 5G new radio, and a 5G network device is deployed on the satellite and connected to a terrestrial core network through a radio link. In addition, a radio link exists between satellites to implement signaling exchange and user data transmission between network devices. In the embodiments, the satellite is referred to as a network device.

The following describes the network elements and interfaces in FIG. 1.

### 1. Terminal

The terminal may be a mobile device that supports 5G new radio, and may access a satellite network through an air interface and initiate services such as calls and Internet access.

The terminal in embodiments of the embodiments may also be referred to as user equipment (UE), a terminal device, a user, an access terminal, a subscriber unit, a subscriber station, a mobile station, a mobile console, a remote station, a remote terminal, a mobile device, a user terminal, a wireless communication device, a user agent, or a user apparatus. The UE may be a cellular phone, a smartwatch, a wireless data card, a mobile phone, a tablet computer, a personal digital assistant (PDA) computer, a wireless modem, a handheld device, a laptop computer, a machine type communication (machine type communication, MTC) terminal, a computer with a wireless transceiver function, an Internet of things terminal, a virtual reality terminal device, an augmented reality terminal device, a wearable device, a vehicle, a terminal in device-to-device (D2D) communication, a terminal in vehicle-to-everything (V2X) communication, a terminal in machine type communication (MTC), a terminal in the Internet of things (IOT), a terminal in smart office, a terminal in industrial control, a terminal in self driving, a terminal in remote surgery, a terminal in a smart grid, a terminal in transportation security, a terminal in a smart city, a terminal in a smart home, and a terminal in satellite communication (for example, a satellite phone or a satellite terminal). The terminal may alternatively be customer-premises equipment (CPE), a telephone, a router, a network switch, a home gateway (residential gateway, RG), a set-top box, a fixed mobile convergence product, a home networking adapter, or an Internet access gateway.

A specific technology and a specific device form that are used by the terminal are not limited.

### 2. Network Device

The network device may also be referred to as a (radio) access network ((R)AN) device, may provide a function of accessing a communication network for an authorized user in a specific area, and may include a wireless network device in a 3rd generation partnership project (3rd generation partnership project, 3GPP) network, or may include an access point in a non-3GPP (non-3GPP) network.

The network device may use different radio access technologies. Currently, there are two types of radio access technologies: a 3GPP access technology (for example, a radio access technology used in a 3rd generation (3G) system, a 4th generation (4G) system, or a 5G system) and a non-3GPP access technology. The 3GPP access technology is an access technology that complies with the 3GPP standard specification. For example, an access network device in the 5G system is referred to as a next generation node base station (gNB) or a RAN device. The non-3GPP access technology may include an air interface technology represented by an access point (AP) in wireless fidelity (Wi-Fi), a worldwide interoperability for microwave access (WiMAX), a code division multiple access (CDMA), and the like. The network device may allow interconnection and interworking performed between the terminal and a 3GPP core network by using the non-3GPP technology.

The network device can be responsible for functions such as radio resource management, quality of service (QOS) management, and data compression and encryption on an air interface side. The AN device provides an access service for the terminal device, to complete forwarding a control signal and user data between the terminal device and the core network. The network device in embodiments of the embodiments may be a network device deployed on the satellite, or may be a network device deployed on the ground.

For example, the network device may include, but is not limited to, a macro base station, a micro base station (also referred to as a small cell), a radio network controller (RNC), a NodeB (NB), a base station controller (BSC), a base transceiver station (BTS), a home NodeB (for example, a home evolved NodeB, or a home NodeB, HNB), a baseband unit (BBU), an AP, a base station (BS) in WiMAX, a wireless relay node, a wireless backhaul node, and a transmission point (TP) or a transmission and reception point (TRP) in a Wi-Fi system, a gNB or a transmission point (TRP or TP) in a 5G (for example, NR) system, one antenna panel or a group of antenna panels (including a plurality of antenna panels) of a base station in a 5G system, and a network node (for example, a baseband unit (BBU) or a distributed unit (DU)) that forms a gNB or a transmission point.

In some deployments, the gNB may include a central unit (CU) and a DU. The gNB may further include an active antenna unit (AAU). The CU implements some functions of the gNB, and the DU implements some functions of the gNB. For example, the CU is responsible for processing a non-real-time protocol and service, and implements functions at a radio resource control (RRC) layer and a packet data convergence protocol (PDCP) layer. The DU is responsible for processing a physical layer protocol and a real-time service, and implements functions at a radio link control (RLC) layer, a media access control (MAC) layer, and a physical (PHY) layer. The AAU implements some physical layer processing functions, radio frequency processing, and a function related to an active antenna. It may be understood that the network device may be a device including one or more of a CU node, a DU node, and an AAU node. In addition, the CU may be classified into a network device in an access network, or the CU may be classified into a network device in a core network (core network, CN). This is not limited.

A specific technology and a specific device form that are used by the network device are not limited.

### 3. User Plane Network Element

The user plane network element serves as an interface to a data network, and implements functions such as user plane data forwarding, session/flow-level charging statistics, and bandwidth throttling, that is, packet routing and forwarding, handling of quality of service (QOS) of user plane data, and the like. In the 5G communication system, the user plane network element may be a user plane function (UPF) network element.

### 4. Data Network

The data network (DN) can be used to provide a data service for the terminal, for example, the Internet, a third-party service network, or an IP multi-media service (IMS) network.

### 5. Mobility Management Network Element

The mobility management network element can be configured to perform mobility management, access management, and the like. In the 5G communication system, the access management network element may be an access and mobility management function (AMF), and can perform functions such as mobility management and access authentication/authorization. In addition, the access management network element is also responsible for transferring a user policy between the terminal and a policy control function (PCF) network element.

### 6. Session Management Network Element

The session management network element can be configured to: manage a session, allocate and manage an Internet protocol (IP) address of user equipment, select an endpoint that can manage a user plane function interface and a policy control and charging function interface, perform downlink data notification, and the like. In the 5G communication system, the session management network element may be a session management function (SMF) network element, and completes terminal IP address allocation, UPF selection, charging and QoS policy control, and the like.

### 7. New Radio

New radio is a radio link between the terminal device and the network device.

### 8. Xn Interface

The Xn interface is an interface between network devices, and can be used for signaling exchange such as handover.

### 9. Satellite Radio Interface (SRI)

When the satellite works in the transparent transmission mode, the SRI is an NR-Uu interface.

When the satellite works in the regenerative mode, the SRI is an NG interface or an F1 interface.

It should be understood that the foregoing network architecture to which embodiments are applied is merely an example for description, and the network architecture to which embodiments are applicable is not limited thereto. Embodiments are applicable to any network architecture that can implement the functions of the foregoing network elements. The foregoing network elements may be independent devices, or may be integrated into a same device to implement different functions, or may be network elements in a hardware device, or may be software functions running on dedicated hardware, or may be instantiated virtualization functions on a platform (for example, a cloud platform). Specific forms of the network elements are not limited.

It should be further understood that the foregoing names are defined merely for distinguishing between different functions, and should not constitute any limitation. The embodiments do not exclude a possibility of using other names in a 6G network and another future network. For example, in the 6G network, a part or all of the foregoing network elements may still use terms in 5G, or may use other names.

Channel fading exists in communication channels of various communication systems, and diversity in time domain, frequency domain, or spatial domain may be used to improve coverage performance of a radio link. For example, when channel fading exists in the communication channel, a time diversity gain may be obtained by performing repeated transmission in time domain. When channel fading exists in the communication channel, a frequency diversity gain may be obtained by performing frequency hopping transmission in frequency domain. When channel fading exists in the communication channel, a spatial diversity gain may be obtained by performing multi-antenna transmission in spatial domain. When the network device communicates with the terminal device, the terminal device is affected by factors such as power consumption, costs, and a size. Although a plurality of antennas are configured to implement multi-antenna receiving, when the terminal device fixedly uses a single antenna or several antennas to send a signal during transmission, a spatial diversity gain of a sent signal cannot be implemented. Consequently, communication may be interrupted, network efficiency may be low, and the like.

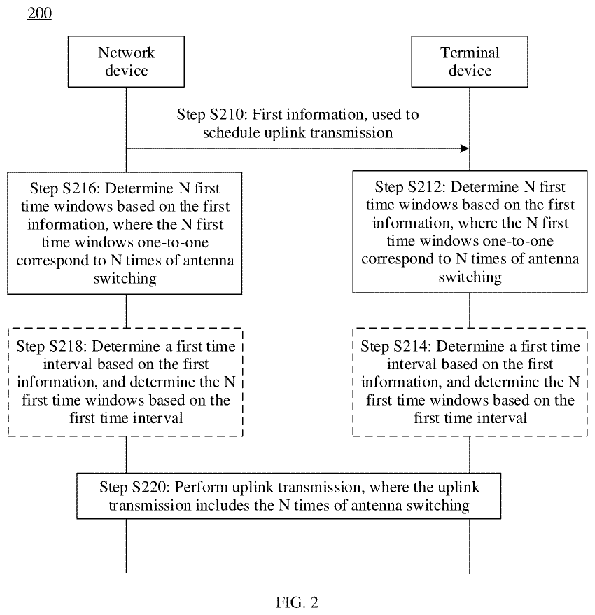

To resolve the foregoing problems, the embodiments provide a communication method 200, as shown in FIG. 2.

Step S210: A network device sends first information to a terminal device, where the first information is used to schedule uplink transmission.

Optionally, the first information may be referred to as scheduling information. A name of the first information is not limited.

For example, the first information may include at least one of the following information:
a number of slots for repetition (number of repetitions), a number of slots for transport block processing over multiple slots (TBoMS), third information, a time window #1 (TDW), an indication of whether to support restart of a time window #2, and the like.

The number of slots for repetition for TBoMS means that one transport block (TB) is sent in uplink transmission in a plurality of slots. In comparison with one TB sent in one slot, a lower modulation and coding scheme may be used for the TBoMS, to improve a coding gain. This further enhances uplink coverage. The third information indicates whether joint channel estimation (JCE) is allowed or enabled, and the JCE is performing channel estimation, based on demodulation reference signals (DMRS) sent in a plurality of slots, on physical uplink shared channels (PUSCH)/physical uplink control channels (PUCCH) transmitted in the plurality of slots, to improve a gain of uplink channel estimation. This further enhances PUSCH/PUCCH coverage. The time window #1 is a TDW used for the JCE. When the terminal device cannot meet requirements of power consistency and phase continuity of sent signals in the large time window #1, a plurality of small time windows #2 are needed. In other words, the terminal device needs to maintain power consistency and phase continuity in the plurality of small time windows #2. The indication of whether to support the restart of the time window #2 means whether to trigger the restart of the time window #2 after the time window #2 ends. The large time window #1 includes the plurality of small time windows #2. The time window #2 is an example of a first time window.

The time window #1 automatically restarts by default in the time window for continuous scheduling of the network device.

It should be noted that the number of slots for repetition may indicate a number of consecutive slots used for uplink transmission, or the number of slots for repetition may indicate time lengths of consecutive slots used for uplink transmission. The number of slots for TBoMS may indicate a number of slots used for uplink transmission of one TB, or the number of slots for TBoMS may indicate time lengths of a plurality of slots used for uplink transmission of one TB.

It should be understood that the number of slots for repetition or the number of slots for TBoMS in the following formulas may be represented as a number of slots, or may be represented as time lengths of slots. This is not limited.

For example, the JCE may also be considered as PUSCH/PUCCH-DMRS bundling (PUSCH/PUCCH-DMRS bundling).

For example, the uplink transmission may be transmission of an uplink channel, an uplink signal, uplink data, or the like. Specific content of the uplink transmission is not limited.

For example, “support” and “allow” in the foregoing may also be referred to as enabling. This is not limited.

Step S212: The terminal device determines N first time windows based on the first information, where the N first time windows are used for the uplink transmission.

Optionally, in step S214, the terminal device may further determine a first time interval based on the first information, and determine the N first time windows based on the first time interval.

For example, the uplink transmission includes N times of antenna switching, and the N first time windows one-to-one correspond to the N times of antenna switching.

For example, when the first information indicates that the network device requires to enable PUSCH/PUCCH-DMRS bundling (or the network device requires to enable the JCE), and the number of slots for repetition included in the first information is greater than 1, the first time interval=┌γ*the number of slots for TBoMS┐.

γ is a weighting factor of the TBoMS in the JCE, and indicates a weight of a coding gain of the TBoMS in a channel estimation gain of the JCE. A value of γ may be indicated by the network device to the terminal device through broadcast signaling (for example, a system information block (SIB)), or may be a pre-configured default value, and the default value is a real number greater than 0 and less than or equal to 1. ┌.┐ indicates a rounding up operation, to obtain a minimum integer that is greater than a current real number obtained through calculation.

It should be noted that if the number of slots for repetition or the number of slots for TBoMS in the foregoing formula represent a number of slots, the first time interval may also be a number of slots. Alternatively, if the number of slots for repetition or the number of slots for TBoMS in the foregoing formula represent time lengths of slots, the first time interval may also be a time length. This is not limited.

Meanings represented by the first time interval in the following steps are similar to those described herein. Details are not described again in the following.

Step S216: The network device determines the N first time windows based on the first information.

Optionally, in step S218, the network device may further determine the first time interval based on the first information, and determine the N first time windows based on the first time interval.

For example, the network device may determine the first time interval by using a same calculation method as that of the terminal device in step S214.

Step S220: The terminal device performs uplink transmission with the network device.

For example, the terminal device performs the N times of antenna switching during the uplink transmission.

According to the method 200, balance between a coding gain, a joint channel estimation gain, and a spatial diversity gain can be achieved, and proper communication quality of uplink transmission can be obtained.

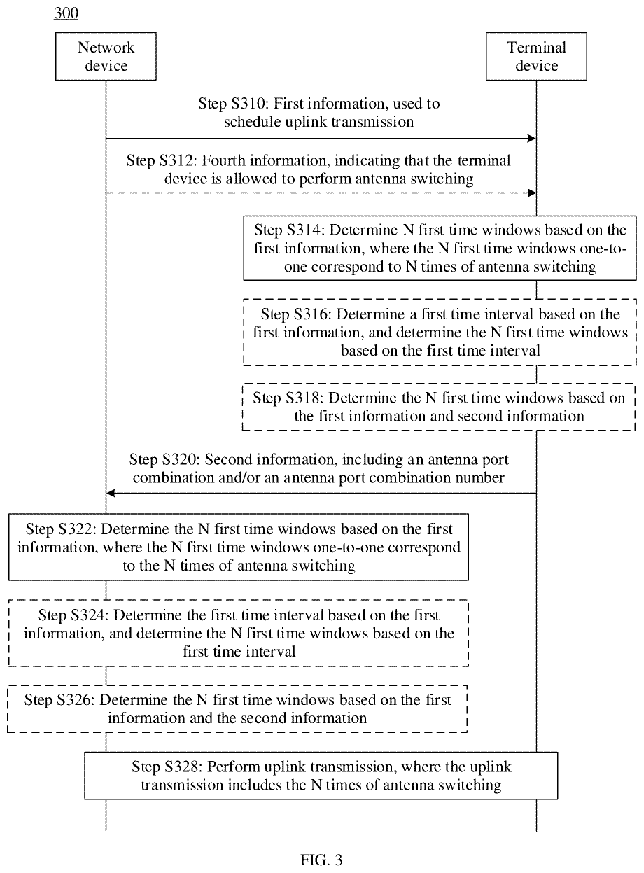

The foregoing method is applicable to a conventional terminal device that does not support reporting an antenna switching capability to a network device. For a terminal device that supports reporting an antenna switching capability to a network device, the embodiments may further provide another communication method 300, as shown in FIG. 3. Further, it should be understood that the word “step” may also be understood as an operation or block.

Step S310: A network device sends first information to a terminal device, where the first information is used to schedule uplink transmission.

Optionally, the first information may be referred to as scheduling information. A name of the first information is not limited.

For example, the first information may include at least one of the following information:
a number of slots for repetition, a number of slots for TBoMS, third information, a time window #1, an indication of whether to support restart of a time window #2, and the like.

The number of slots for repetition for TBoMS means that one TB is sent in uplink transmission in a plurality of slots. In comparison with one TB sent in one slot, a lower modulation and coding scheme may be used for the TBoMS, to improve a coding gain. This further enhances uplink coverage. The third information indicates whether JCE is allowed or enabled, and the JCE is performing channel estimation, based on DMRSs sent in a plurality of slots, on PUSCHs/PUCCHs transmitted in the plurality of slots, to improve a gain of uplink channel estimation. This further enhances PUSCH/PUCCH coverage. The time window #1 is a TDW used for the JCE. When the terminal device cannot meet requirements of power consistency and phase continuity in the large time window #1, a plurality of small time windows #2 are needed. In other words, the terminal device needs to maintain power consistency and phase continuity in the plurality of small time windows #2. The indication of whether to support restart of the time window #2 means whether to trigger restart of the time window #2 after the time window #2 ends. The large time window #1 includes the plurality of small time windows #2. The time window #2 is an example of a first time window.

For example, the JCE may also be considered as PUSCH/PUCCH-DMRS bundling (PUSCH/PUCCH-DMRS bundling).

For example, the uplink transmission may be transmission of an uplink channel, an uplink signal, uplink data, or the like. Specific content of the uplink transmission is not limited.

For example, “support”, “allow”, and “require to enable” in the embodiments may also be referred to as enabling. This is not limited.

Optionally, in step S312, the network device sends fourth information to the terminal device, where the fourth information indicates that the terminal device is allowed to perform antenna switching.

Step S314: The terminal device determines N first time windows based on the first information, where the N first time windows are used for the uplink transmission.

Optionally, in step S316, the terminal device may further determine a first time interval based on the first information, and determine the N first time windows based on the first time interval.

For example, the uplink transmission includes N times of antenna switching, and the N first time windows one-to-one correspond to the N times of antenna switching.

For example, when the first information indicates that the network device does not require to enable PUSCH/PUCCH-DMRS bundling, and the number of slots for repetition included in the first information is greater than 1, the first time interval=┌α*the number of slots for TBoMS┐.

α is a weighting factor of the TBoMS, and indicates a weight of a coding gain of the TBoMS. A value of α may be indicated by the network device to the terminal device through broadcast signaling (for example, a SIB), or may be a pre-configured default value, and the default value is a real number greater than 0 and less than or equal to 1. ┌.┐ indicates a rounding up operation, to obtain a minimum integer that is greater than a current real number obtained through calculation.

When the first information indicates that the network device does not require to enable PUSCH/PUCCH-DMRS bundling, in a possible implementation or embodiment, the first time interval=┌the number of slots for TBoMS÷2┐.

When the first information indicates that the network device does not require to enable PUSCH/PUCCH-DMRS bundling, in another possible implementation or embodiment, when the number of slots for TBoMS included in the first information is 1 or the first information does not include the number of slots for TBoMS, the first time interval=1.

Optionally, in step S318, the terminal device determines the N first time windows based on the first information and second information.

For example, the second information indicates a number of antenna port combinations used by the terminal device for antenna switching, which is denoted as a first parameter; or the second information indicates an antenna switching capability of the terminal device.

For example, it is assumed that the terminal device is equipped with four antennas that are marked as an antenna 1, an antenna 2, an antenna 3, and an antenna 4. An antenna port number that can be used by the terminal device for signal transmission may be 1, 2, 3, or 4. An antenna combination in which the antenna port number for signal transmission is 1 may be classified into four cases: [antenna 1], [antenna 2], [antenna 3], and [antenna 4]. An antenna combination in which the antenna port number for signal transmission is 2 may be classified into six cases: [antenna 1, antenna 2], [antenna 1, antenna 3], [antenna 1, antenna 4], [antenna 2, antenna 3], [antenna 2, antenna 4], and [antenna 3, antenna 4]. An antenna combination in which the antenna port number for signal transmission is 3 may be classified into four cases: [antenna 1, antenna 2, antenna 3], [antenna 1, antenna 2, antenna 4], [antenna 1, antenna 3, antenna 4], and [antenna 2, antenna 3, antenna 4]. An antenna combination in which the antenna port number for signal transmission is 4 may be classified into one case: [antenna 1, antenna 2, antenna 3, antenna 4].

The second information may include at least one antenna port combination corresponding to each of at least one number of antenna ports used by the terminal device for signal transmission, or the second information may include at least one antenna port combination number corresponding to each of at least one number of antenna ports used by the terminal device for signal transmission. This is not limited.

For example, the second information may include antenna combinations: [antenna 1], [antenna 2], and [antenna 3] corresponding to the antenna port number of 1, or the second information may include an antenna combination number of 3 that corresponds to the antenna port number of 1.

Optionally, the network device may indicate the terminal device to transmit signals by using a signal antenna, two antennas, or the like. If the network device indicates the terminal device to transmit a signal by using a signal antenna, the terminal device transmits the signal through one antenna port, and an antenna combination number may be 1,2, 3, or 4.

For example, when the first information indicates that the network device requires to enable PUSCH/PUCCH-DMRS bundling, and the number of slots for repetition included in the first information is greater than 1, the first time interval=┌(β*the number of slots for TBoMS*the number of slots for repetition)÷the first parameter┐.

β is a weighting factor of the TBoMS in the JCE, and indicates a weight of a coding gain of the TBoMS in a channel estimation gain of the JCE. A value of β may be indicated by the network device to the terminal device through broadcast signaling (for example, a SIB), or may be a pre-configured default value, and the default value is a real number greater than 0 and less than or equal to 1. ┌.┐ indicates a rounding up operation, to obtain a minimum integer that is greater than a current real number obtained through calculation.

When the first information indicates that the network device requires to enable PUSCH/PUCCH-DMRS bundling, in a possible implementation or embodiment, the first time interval=┌(the number of slots for TBoMS*the number of slots for repetition)÷the first parameter┐.

When the first information indicates that the network device requires to enable PUSCH/PUCCH-DMRS bundling, in another possible implementation or embodiment, when the number of slots for TBoMS included in the first information is 1 or the first information does not include the number of slots for TBoMS, the first time interval=┌the number of slots for repetition÷the first parameter┐.

When the first information indicates that the network device requires to enable PUSCH/PUCCH-DMRS bundling, in another possible implementation or embodiment, when the number of slots for TBoMS included in the first information is 1 or the first information does not include the number of slots for TBoMS, and the terminal device does not support reporting of the second information to the network device, the first time interval=┌the number of slots for repetition÷k┐, where k may be 4.

Step S320: The terminal device sends the second information to the network device.

Step S322: The network device determines the N first time windows based on the first information.

Optionally, in step S324, the network device determines the first time interval based on the first information, and determines the N first time windows based on the first time interval.

For example, the network device may determine the first time interval by using a same calculation method as that of the terminal device in step S316.

Optionally, in step S326, the network device determines the N first time windows based on the first information and the second information.

For example, the network device may determine the first time interval by using a same calculation method as that of the terminal device in step S318.

Step S328: The terminal device performs uplink transmission with the network device.

For example, the terminal device performs the N times of antenna switching during the uplink transmission.

According to the method 300, balance between a coding gain, a channel estimation gain, and a spatial diversity gain can be achieved, and proper communication quality of uplink transmission can be obtained.

In an implementation or embodiment, the first information may further include a second time interval (frequency hopping interval) for a frequency hopping operation in the uplink transmission performed by the terminal device. When the first information indicates that the network device does not require to enable PUSCH/PUCCH-DMRS bundling, the first time interval=max(┌the number of slots for TBoMS÷2┐, ┌a first frequency interval÷2┐). When the first information indicates that the network device requires to enable PUSCH/PUCCH-DMRS bundling, the first time interval=┌(the number of slots for TBoMS×the number of slots for repetition)÷min(the first parameter, the number of slots for repetition÷the second time interval)┐.

The terminal device and the network device perform uplink transmission based on the time interval calculated based on the foregoing manner, to achieve balance between a coding gain, a channel estimation gain, a frequency diversity gain, and a spatial diversity gain, and obtain proper communication quality of uplink transmission.

It should be understood that sequence numbers of the foregoing processes do not mean execution sequences. The execution sequence of the processes should be determined based on functions and internal logic of the processes, and should not be construed as any limitation on implementation processes of embodiments.

It should be further understood that, in embodiments, unless otherwise stated or there is a logic conflict, terms and/or descriptions in different embodiments are consistent and may be mutually referenced, and features in different embodiments may be combined based on an internal logical relationship thereof, to form a new embodiment.

It should be further understood that, in some of the foregoing embodiments, a device in an existing network architecture can be used as an example for description. It should be understood that a specific form of the device is not limited in embodiments. For example, all devices that can implement a same function in the future are applicable to embodiments.

It may be understood that, in the foregoing method embodiments, the method and the operation implemented by the device (such as the transmit device or the receive device) may also be implemented by a component (for example, a chip or a circuit) of the device.

The methods provided in embodiments are described above in detail with reference to FIG. 2 and FIG. 3. The foregoing methods are described from a perspective of interaction between the terminal device and the network device. It may be understood that, to implement the foregoing functions, the terminal device and the network device include corresponding hardware structures and/or software modules for performing the functions.

A person skilled in the art may be aware that, in combination with units and algorithm steps of the examples described in embodiments, the embodiments may be implemented by hardware or a combination of hardware and computer software. Whether a function is performed by hardware or hardware driven by computer software depends on particular applications and design constraints of the solutions. A person skilled in the art may use different methods to implement the described functions for each particular application, but it should not be considered that the implementation or embodiment goes beyond the scope of the embodiments.

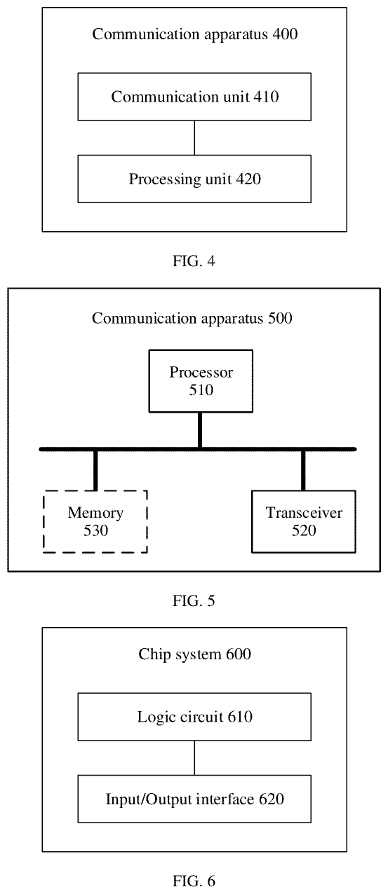

The following describes in detail a communication apparatus in embodiments with reference to FIG. 4 to FIG. 6. It should be understood that descriptions of apparatus embodiments correspond to the descriptions of the method embodiments. Therefore, for content that is not described in detail, refer to the foregoing method embodiments. For brevity, some content is not described again. In embodiments, functional modules of the transmit device or the receive device may be obtained through division based on the foregoing method examples. For example, functional modules may be obtained through division based on functions, or two or more functions may be integrated into one processing module. The integrated module may be implemented in a form of hardware, or may be implemented in a form of a software functional module. It should be noted that, in embodiments, module division is an example, and is merely logical function division. In actual implementation, another division manner may be used. An example in which each functional module is obtained through division based on each corresponding function is used below for description.

The foregoing describes in detail the method provided in the embodiments. The following describes a communication apparatus provided in the embodiments. In a possible implementation or embodiment, the apparatus is configured to implement the steps or procedures corresponding to the terminal device in the foregoing method embodiments. In another possible implementation or embodiment, the apparatus is configured to implement the steps or procedures corresponding to the network device in the foregoing method embodiments.

FIG. 4 is a block diagram of a communication apparatus 400 according to an embodiment. As shown in FIG. 4, the apparatus 400 may include a communication unit 410 and a processing unit 420. The communication unit 410 may communicate with an external device, and the processing unit 420 is configured to process data. The communication unit 410 may also be referred to as a communication interface or a transceiver unit.

In a possible embodiment, the apparatus 400 may implement the steps or procedures performed by the terminal device in the foregoing method embodiments. The processing unit 420 is configured to perform processing-related operations of the terminal device in the foregoing method embodiments, and the communication unit 410 is configured to perform sending-related operations of the terminal device in the foregoing method embodiments.

In another possible embodiment, the apparatus 400 may implement the steps or procedures performed by the network device in the foregoing method embodiments. The communication unit 410 is configured to perform receiving-related operations of the network device in the foregoing method embodiments. The processing unit 420 is configured to perform processing-related operations of the network device in the foregoing method embodiments.

It should be understood that the apparatus 400 herein is embodied in a form of a functional unit. The term “unit” herein may refer to an application-specific integrated circuit (ASIC), an electronic circuit, a processor (for example, a shared processor, a dedicated processor, or a group processor) configured to execute one or more software or firmware programs, a memory, a merged logic circuit, and/or another proper component that supports the described function. In an optional example, a person skilled in the art may understand that the apparatus 400 may be the terminal device in the foregoing embodiments, and may be configured to perform procedures and/or steps corresponding to the terminal device in the foregoing method embodiments; or the apparatus 400 may be the network device in the foregoing embodiments, and may be configured to perform procedures and/or steps corresponding to the network device in the foregoing method embodiments. To avoid repetition, details are not described herein again.

The apparatus 400 in each of the foregoing solutions has functions of implementing the corresponding steps performed by the terminal device in the foregoing methods, or the apparatus 400 in each of the foregoing solutions has functions of implementing the corresponding steps performed by the network device in the foregoing methods. The functions may be implemented by hardware, or may be implemented by hardware executing corresponding software. The hardware or software includes one or more modules corresponding to the foregoing functions. For example, the communication unit may be replaced with a transceiver (for example, a sending unit of the communication unit may be replaced with a transmitter, and a receiving unit of the communication unit may be replaced with a receiver), and another unit like the processing unit may be replaced with a processor, to separately perform the sending/receiving operations and the processing-related operations in the method embodiments.

In addition, the communication unit may alternatively be a transceiver circuit (for example, may include a receiving circuit and a sending circuit), and the processing unit may be a processing circuit. In embodiments, the apparatus in FIG. 4 may be the terminal device or the network device in the foregoing embodiments, or may be a chip or a chip system, for example, a system on chip (SoC). The communication unit may be an input/output circuit or a communication interface. The processing unit is a processor, a microprocessor, or an integrated circuit integrated on the chip. This is not limited herein.

FIG. 5 is a block diagram of a communication apparatus 500 according to an embodiment. The apparatus 500 includes a processor 510 and a transceiver 520. The processor 510 and the transceiver 520 communicate with each other through an internal connection path, and the processor 510 is configured to execute instructions, to control the transceiver 520 to send a signal and/or receive a signal.

Optionally, the apparatus 500 may further include a memory 530. The memory 530 communicates with the processor 510 and the transceiver 520 through internal connection paths. The memory 530 is configured to store instructions, and the processor 510 may execute the instructions stored in the memory 530. In a possible implementation or embodiment, the apparatus 500 is configured to implement procedures and steps corresponding to the terminal device in the foregoing method embodiments. In another possible implementation or embodiment, the apparatus 500 is configured to implement procedures and steps corresponding to the network device in the foregoing method embodiments.

It should be understood that the apparatus 500 may be the terminal device or the network device in the foregoing embodiments, or may be a chip or a chip system. Correspondingly, the transceiver 520 may be a transceiver circuit of the chip. This is not limited herein. For example, the apparatus 500 may be configured to perform steps and/or procedures corresponding to the terminal device or the network device in the foregoing method embodiments. Optionally, the memory 530 may include a read-only memory and a random access memory, and provide the instructions and data for the processor. A part of the memory may further include a non-volatile random access memory. For example, the memory may further store information of a device type. The processor 510 may be configured to execute the instructions stored in the memory, and when the processor 510 executes the instructions stored in the memory, the processor 510 is configured to perform steps and/or procedures corresponding to the terminal device or the network device in the foregoing method embodiments.

In an implementation process, steps in the foregoing methods can be implemented by using a hardware integrated logical circuit in the processor, or by using instructions in a form of software. The steps in the methods with reference to embodiments may be directly performed and completed by a hardware processor, or may be performed and completed by using a combination of hardware in the processor and a software module. A software module may be located in a mature storage medium in the art, for example, a random access memory, a flash memory, a read-only memory, a programmable read-only memory, an electrically erasable programmable memory, or a register. The storage medium is located in the memory, and a processor reads information in the memory and completes the steps in the foregoing methods in combination with hardware of the processor. To avoid repetition, details are not described herein again.

It should be noted that, the processor in embodiments may be an integrated circuit chip, and has a signal processing capability. In an implementation process, steps in the foregoing method embodiments can be implemented by using a hardware integrated logical circuit in the processor, or by using instructions in a form of software. The processor may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor in embodiments may implement or perform the methods, the steps, and the logical block diagrams that are in embodiments. The general-purpose processor may be a microprocessor, or the processor may be any conventional processor or the like. The steps in the methods with reference to embodiments may be directly performed and completed by a hardware decoding processor, or may be performed and completed by using a combination of hardware in the decoding processor and a software module. A software module may be located in a mature storage medium in the art, for example, a random access memory, a flash memory, a read-only memory, a programmable read-only memory, an electrically erasable programmable memory, or a register. The storage medium is located in the memory, and a processor reads information in the memory and completes the steps in the foregoing methods in combination with hardware of the processor.

It may be understood that the memory in this embodiment may be a volatile memory or a nonvolatile memory, or may include a volatile memory and a nonvolatile memory. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM), used as an external cache. By way of example rather than limitation, a plurality of forms of RAMs may be used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synchlink DRAM, SLDRAM), and a direct rambus dynamic random access memory (direct rambus RAM, DR RAM). It should be noted that the memory of the systems and methods described includes, but is not limited to, these memories and any memory of another appropriate type.

It should be noted that when the processor is a general-purpose processor, a DSP, an ASIC, an FPGA or another programmable logic device, a discrete gate or a transistor logic device, or a discrete hardware component, the memory (storage module) may be integrated into the processor. It should further be noted that the memory described is intended to include, but is not limited to, these memories and any memory of another appropriate type.

FIG. 6 is a diagram of a chip system 600 according to an embodiment. The chip system 600 (may also be referred to as a processing system) includes a logic circuit 610 and an input/output interface (input/output interface) 620.

The logic circuit 610 may be a processing circuit in the chip system 600. The logic circuit 610 may be coupled to and connected to a storage unit, and invoke instructions in the storage unit, so that the chip system 600 to implement the methods and functions in embodiments. The input/output interface 620 may be an input/output circuit in the chip system 600, and outputs information processed by the chip system 600, or inputs to-be-processed data or signaling into the chip system 600 for processing.

For example, if the chip system 600 is installed in the terminal device, the logic circuit 610 is coupled to the input/output interface 620, and the logic circuit 610 may send a first parameter through the input/output interface 620. The first parameter may be generated by the logic circuit 610. For another example, if the chip system 600 is installed in the network device, the logic circuit 610 is coupled to the input/output interface 620, and the logic circuit 610 may receive the first parameter through the input/output interface 620.

In a solution or embodiment, the chip system 600 is configured to implement operations performed by the terminal device in the foregoing method embodiments.

For example, the logic circuit 610 is configured to implement processing-related operations performed by the terminal device in the foregoing method embodiments, for example, processing-related operations performed by the terminal device in the embodiment shown in FIG. 2 or FIG. 3. The input/output interface 620 is configured to implement sending and/or receiving-related operations performed by the terminal device in the foregoing method embodiments, for example, processing-related operations performed by the terminal device in the embodiment shown in FIG. 2 or FIG. 3.

In another solution or embodiment, the chip system 600 is configured to implement operations performed by the network device in the foregoing method embodiments.

For example, the logic circuit 610 is configured to implement processing-related operations performed by the network device in the foregoing method embodiments, for example, processing-related operations performed by the network device in the embodiment shown in FIG. 2 or FIG. 3. The input/output interface 620 is configured to implement sending and/or receiving-related operations performed by the network device in the foregoing method embodiments, for example, processing-related operations performed by the network device in the embodiment shown in FIG. 2 or FIG. 3.

In addition, the embodiments further provide a non-transitory computer-readable storage medium. The non-transitory computer-readable storage medium stores computer instructions. When the computer instructions are run on a computer, operations and/or procedures performed by the terminal device or the network device in the method embodiments are performed.

The embodiments further provide a computer program product. The computer program product includes computer program code or instructions. When the computer program code or the instructions are run on a computer, operations and/or procedures performed by the terminal device or the network device in the method embodiments are performed.

In addition, the embodiments further provide a communication system. The communication system includes the terminal device and the network device in embodiments.

It should further be noted that the memory described in the embodiments is intended to include, but is not limited to, these memories and any memory of another appropriate type.

A person of ordinary skill in the art may be aware that, in combination with the examples described in embodiments, units and algorithm steps may be implemented by electronic hardware or a combination of computer software and electronic hardware. Whether the functions are performed by hardware or software depends on particular applications and design constraints of the solutions. A person skilled in the art may use different methods to implement the described functions for each particular application, but it should not be considered that the implementation or embodiment goes beyond the scope of the embodiments. It may be clearly understood by a person skilled in the art that, for the purpose of convenient and brief description, for a detailed working process of the foregoing system, apparatus, and unit, refer to a corresponding process in the foregoing method embodiments. Details are not described herein again. In the several embodiments provided, it should be understood that the system, apparatus, and method may be implemented in other manners. For example, the described apparatus embodiments are merely examples. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms. The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments. In addition, functional units in embodiments may be integrated into one processing unit, each of the units may exist alone physically, or two or more units are integrated into one unit.

When the functions are implemented in the form of a software functional unit and sold or used as an independent product, the functions may be stored in a non-transitory computer-readable storage medium. Based on such an understanding, the solutions of the embodiments essentially, the part contributing to the conventional technology, or a part of the solutions may be implemented in a form of a software product. The computer software product is stored in a storage medium, and includes several instructions for enabling a computing device (which may be a personal computer, a server, a network device, or the like) to perform all or some of the steps of the methods described in embodiments. The foregoing storage medium includes any medium that can store program code, for example, a USB flash drive, a removable hard disk, a ROM, a RAM, a magnetic disk, or an optical disc.

It should be understood that an “embodiment” mentioned throughout means that particular features, structures, or characteristics related to this embodiment are included in at least one embodiment. Therefore, embodiments throughout do not necessarily refer to a same embodiment. In addition, these particular features, structures, or characteristics may be combined in one or more embodiments by using any appropriate manner.

It should be further understood that ordinal numbers such as “first” and “second” mentioned in embodiments are used to distinguish between a plurality of objects, and are not intended to limit sizes, content, an order, a time sequence, priorities, importance, or the like of the plurality of objects. For example, the first information and the second information do not indicate a difference in an information amount, content, a priority, importance, or the like.

It should be further understood that, in the embodiments, both “when” and “if” mean that a network element performs corresponding processing in an objective situation, but do not constitute a limitation on time, do not require that the network element has a determining action during implementation, and do not mean other limitations either.

It should be further understood that, in the embodiments, “at least one” means one or more, and “a plurality of” means two or more. “At least one of items (pieces)” or a similar expression thereof refers to one item (piece) or a plurality of items (pieces), that is, any combination of these items, including any combination of singular items (pieces) or plural items (pieces). For example, at least one of a, b, or c may represent a, b, c, a and b, a and c, b and c, or a, b, and c.

It should be further understood that, unless otherwise specified, a meaning similar to “an item includes at least one of the following: A, B, and C” in the embodiments can mean that the item may be any one of the following: A; B; C; A and B; A and C; B and C; A, B and C; A and A; A, A and A; A, A and B; A, A and C; A, B and B; A, C and C; B and B, B, B and B, B, B and C, C and C; C, C and C, and other combinations of A, B, and C. The foregoing uses three elements A, B, and C as an example to describe an optional case of the item. When an expression is “an item includes at least one of the following: A, B, . . . , and X”, that is, when more elements are included in the expression, a case to which the item is applicable may also be obtained according to the foregoing rule.

It should be further understood that, the term “and/or” in the embodiments describes only an association relationship between associated objects, and represents that three relationships may exist. For example, A and/or B may represent the following cases: A exists alone, both A and B exist, and B exists alone, where A and B may be singular or plural. The character “/” generally indicates an “or” relationship between the associated objects. For example, A/B indicates A or B.

It should be further understood that in embodiments, “B corresponding to A” indicates that B is associated with A, and B may be determined based on A. However, it should be further understood that determining B based on A does not mean that B is determined based only on A. B may alternatively be determined based on A and/or other information.

The foregoing descriptions are merely specific implementations of the embodiments, but are not intended as limiting. Any variation or replacement readily figured out by a person skilled in the art shall fall within the scope of the embodiments.

1. A method comprising:
receiving, by a first communication apparatus, first information from a network device, wherein the first information is used to schedule uplink transmission; and
determining, by the first communication apparatus, N first time windows based on the first information, wherein the N first time windows are used for the uplink transmission, the uplink transmission comprises N times of antenna switching, and the N first time windows one-to-one correspond to the N times of antenna switching.

2. The method according to claim 1, wherein determining, by the first communication apparatus, the N first time windows based on the first information comprises:
determining, by the first communication apparatus, a first time interval based on the first information; and
determining, by the first communication apparatus, the N first time windows based on the first time interval.

3. The method according to claim 1, further comprising:
sending, by the first communication apparatus, second information to the network device, wherein the second information comprises at least one antenna port combination corresponding to each of at least one number of antenna ports used by the first communication apparatus to perform the uplink transmission, and/or
the second information comprises at least one antenna port combination number corresponding to each of at least one number of antenna ports used by the first communication apparatus to perform the uplink transmission.

4. The method according to claim 1, wherein the first information further indicates a number of antenna ports used by the first communication apparatus to perform the uplink transmission.

5. The method according to claim 1, wherein determining, by the first communication apparatus, the N first time windows based on the first information comprises:
determining, by the first communication apparatus, the N first time windows based on the first information and the second information.

6. The method according to claim 1, wherein the first information comprises at least one of:
a number of slots for repetition in the uplink transmission, a number of slots for transport block processing over multiple slots (TBoMS) in the uplink transmission, and third information, wherein the third information indicates whether joint channel estimation (JCE) is allowed, and the JCE is performing channel estimation, based on demodulation reference signals (DMRS) sent in a plurality of slots, on physical uplink control channels (PUCCHs)/physical uplink shared channels (PUSCHs) transmitted in the plurality of slots.

7. The method according to claim 1, wherein the first information further comprises a second time interval, and the second time interval is a time interval for a frequency hopping operation in the uplink transmission performed by the first communication apparatus.

8. A method comprising:
sending, by a second communication apparatus, first information to a terminal device, wherein the first information is used to schedule uplink transmission; and
determining, by the second communication apparatus, N first time windows based on the first information, wherein the N first time windows are used for the uplink transmission, the uplink transmission comprises N times of antenna switching, and the N first time windows one-to-one correspond to the N times of antenna switching.

9. The method according to claim 8, wherein determining, by the second communication apparatus, the N first time windows based on the first information comprises:
determining, by the second communication apparatus, a first time interval based on the first information; and
determining, by the second communication apparatus, the N first time windows based on the first time interval.

10. The method according to claim 8, further comprising:
receiving, by the second communication apparatus, second information from the terminal device, wherein the second information comprises at least one antenna port combination corresponding to each of at least one number of antenna ports used by the terminal device to perform the uplink transmission, and/or
the second information comprises at least one antenna port combination number corresponding to each of at least one number of antenna ports used by the terminal device to perform the uplink transmission.

11. The method according to claim 8, wherein the first information further indicates a number of antenna ports used by the terminal device to perform the uplink transmission.

12. The method according to claim 8, wherein determining, by the second communication apparatus, the N first time windows based on the first information comprises:
determining, by the second communication apparatus, the N first time windows based on the first information and the second information.

13. The method according to claim 8, wherein the first information comprises at least one of:
a number of slots for repetition in the uplink transmission, a number of slots for transport block processing over multiple slots (TBoMS) in the uplink transmission, and third information, wherein the third information indicates whether the second communication apparatus allows joint channel estimation JCE, and the JCE is performing channel estimation, based on demodulation reference signals (DMRS) sent in a plurality of slots, on physical uplink control channels (PUCCHs)/physical uplink shared channels (PUSCHs) transmitted in the plurality of slots.

14. An apparatus, comprising:
at least one processor; and
one or more memories coupled to the at least one processor and storing program instructions for execution by the at least one processor to:
receive first information from a network device, wherein the first information is used to schedule uplink transmission; and
determine N first time windows based on the first information, wherein the N first time windows are used for the uplink transmission, the uplink transmission comprises N times of antenna switching, and the N first time windows one-to-one correspond to the N times of antenna switching.

15. The apparatus according to claim 14, wherein determination of the N first time windows based on the first information comprises:
determination of a first time interval based on the first information; and
determination of the N first time windows based on the first time interval.

16. The apparatus according to claim 14, wherein the one or more memories storing program instructions for execution by the at least one processor further cause the processor to:
send second information to the network device, wherein the second information comprises at least one antenna port combination corresponding to each of at least one number of antenna ports used by the first communication apparatus to perform the uplink transmission, and/or
the second information comprises at least one antenna port combination number corresponding to each of at least one number of antenna ports used by the first communication apparatus to perform the uplink transmission.

17. The apparatus according to claim 14, wherein the first information further indicates a number of antenna ports used by the first communication apparatus to perform the uplink transmission.

18. The apparatus according to claim 14, wherein determination of the N first time windows based on the first information comprises:
determine the N first time windows based on the first information and the second information.

19. The apparatus according to claim 14, wherein the first information comprises at least one of:
a number of slots for repetition in the uplink transmission, a number of slots for transport block processing over multiple slots TBoMS in the uplink transmission, and third information, wherein the third information indicates whether joint channel estimation JCE is allowed, and the JCE is performing channel estimation, based on demodulation reference signals (DMRS) sent in a plurality of slots, on physical uplink control channels (PUCCHs)/physical uplink shared channels (PUSCHs) transmitted in the plurality of slots.

20. The apparatus according to claim 14, wherein the first information further comprises a second time interval, and the second time interval is a time interval for a frequency hopping operation in the uplink transmission performed by the first communication apparatus.
